(19) United States
(12) Patent Application Publication
(10) Pub. No.: US 2024/0344922 A1
(43) Pub. Date: Oct. 17, 2024

(54) INSPECTION SYSTEM

(71) Applicant: MITSUBISHI HEAVY INDUSTRIES, LTD., Tokyo (JP)

(72) Inventor: Yosuke SAKAI, Tokyo (JP)

(21) Appl. No.: 18/683,089

(22) PCT Filed: Aug. 10, 2022
(86) PCT No.: PCT/JP2022/030662

§ 371 Date: Feb. 12, 2024

(30) Foreign Application Priority Data
Aug. 17, 2021 (JP) 2021-132689
May 26, 2022 (JP) 2022-086029

(51) Int. Cl. G01M 5/00; B64F 5/60

(52) U.S. Cl. CPC G01M 5/0091; B64F 5/60; G01M 5/0033

(57) ABSTRACT

To provide an inspection system with which it is possible to achieve the accuracy of detection suitable for the maintenance of structural soundness while reducing costs by circuit simplification and suppressing an interference with structures in the surrounding of an installed place, an increase in air resistance, and an impact on external appearance. An inspection system applied to moving vehicles, includes a circuit provided on the insulating coating material or non-conducting coating of the structural surface of a moving vehicle and closely attached to the insulating coating material or the non-conducting coating, a sensor terminal connected to the circuit, and an RF antenna terminal connected to an RF antenna, and further includes an RFID IC chip for detecting the electrical continuity state of the circuit.

### TECHNICAL FIELD

The present disclosure relates to an inspection system.

### BACKGROUND ART

In order to ensure soundness during an operation, a periodic inspection is performed on aircraft such as a passenger plane. The periodic inspection is performed by an inspector who visually observes external appearance. PTL 1 and PTL 2 disclose that a defect is detected by using an RFID.

### CITATION LIST

### Patent Literature

[PTL 1] U.S. Pat. No. 7,333,898
[PTL 2] U.S. Pat. No. 7,621,193

### SUMMARY OF INVENTION

### Technical Problem

Since fatigue or damage is accumulated in the aircraft as the number of flights increases, inspections at fixed intervals are obligatory for each airframe. In a visual inspection which is a main inspection method, effort and time are required in proportion to the number of inspection targets and an inspection frequency. In addition, when the airframe progressively decreases in weight, fuel efficiency is improved. However, stress borne by each member increases, and the fatigue or the damage is likely to be accumulated. In this case, frequent inspections are required to maintain the soundness, thereby causing increased operating costs in reverse. On the other hand, when the airframe is designed to have satisfactory damage tolerance strength, the soundness can be maintained and improved without increasing the inspection frequency. However, the design results in deterioration in airframe performance such as a weight increase in the whole airframe and deterioration in fuel efficiency. Therefore, a current aircraft structure is designed to achieve a common ground for an inspection burden and the airframe performance. However, in order to further improve the performance, it is necessary to reduce the inspection burden.

Although PTL 1 discloses that the defect is detected by using the RFID, PTL 1 adopts a method for using a non-destructive inspection, and cannot expect accuracy in precisely detecting damage in units of several millimeters in a moving body structure of the aircraft.

In addition, PTL 2 also proposes a combination of a damage detection method accompanied by destruction of a conductor circuit and a wireless communication device. However, PTL 2 uses a detection device in which a conductor circuit is sandwiched by or covered with insulating films, and it takes time and effort to prepare the device.

In addition, PTL 2 does not specifically disclose strength of the insulating film and the conductor circuit, and an interface or a relationship between the insulating film and the conductor circuit. For example, when the strength of the insulating film or the interface is weaker than the strength of the conductor circuit, even when a base material is damaged, damage inside an insulator or damage to the interface only spreads. The damage cannot completely propagate to the conductor circuit, and the damage cannot always be detected with desired accuracy. Therefore, there is room for improvement in a material of a detection circuit or a cross-sectional shape of a component.

In addition, there is no disclosure of specific values with regard to dimensions of the circuit, the circuit protrudes outward of an installation target, thereby resulting in a probability of inducing an increase in air resistance, interference with a surrounding structure, or deterioration in external appearance.

In addition, in order to drive a sensor connected to the circuit, a receiver has to be prepared separately from a transponder, and electric power has to be supplied. Therefore, the number of configuring members increases, the structure is complicated, and the structure has a large size. Therefore, there is room for improvement in system simplification or cost reduction. On the other hand, when an RF antenna forming an RFID tag is installed at a position close to a conductor such as metal or CFRP, radio waves emitted from an RFID reader do not penetrate the RF antenna, thereby causing a problem in that communication is not established.

The present disclosure is made in view of the above-described circumstances, and an object of the present disclosure is to provide an inspection system which can achieve detection accuracy suitable for maintaining structural soundness while reducing costs by simplifying a circuit, suppressing interference with a structure around an installation place, an increase in air resistance, and an impact on external appearance.

### Solution to Problem

According to a first aspect of the present disclosure, there is provided an inspection system applied to a moving body. The inspection system includes a conductive circuit provided on an insulating coating material or a non-conductor coating on a structural surface of the moving body and closely attached to the insulating coating material or the non-conductor coating, and an RFID IC chip including a sensor terminal connected to the conductive circuit and an RF antenna terminal connected to an RF antenna, and detecting an electrical continuity state of the conductive circuit.

### Advantageous Effects of Invention

According to the present disclosure, an advantageous effect is achieved as follows. An inspection system can improve accuracy in detecting damage in such a manner that a material, a shape, and strength of a conductive circuit of the inspection system are adjusted, and a conductive circuit closely attached to a surface of a moving body is laid by using a specific conductive coating material, a conductive powder, or an adhesive agent. In addition, since the conductive circuit used in the inspection system is thin or fine, it is possible to suppress interference with a surrounding structure when the circuit is installed, an increase in air resistance, and a deterioration in external appearance. In addition, since an RFID IC chip used in the inspection system has a communication function and an inspection function of a damage detection circuit, an advantageous effect is achieved in that the device can be simplified as a whole, can be reduced in weight, and can be reduced in size. In addition, even for an inspection target such as metal or CFRP through which radio waves do not pass, an advantageous effect is achieved in that a remote inspection can be performed by using an RFID reader and the RFID IC chip.

### BRIEF DESCRIPTION OF DRAWINGS

FIG. 1A is a view illustrating a schematic configuration of an inspection system according to an embodiment of the present disclosure.

FIG. 1B is a view illustrating a schematic configuration of the inspection system according to the embodiment of the present disclosure.

FIG. 2 is a view illustrating an example when a circuit according to the embodiment of the present disclosure is disconnected.

FIG. 3 is a view illustrating an example of an RFID reader according to the embodiment of the present disclosure.

FIG. 4 is a view illustrating an installation example of the circuit according to the embodiment of the present disclosure.

FIG. 5 is a view illustrating an installation example of the circuit according to the embodiment of the present disclosure.

FIG. 6 is a view illustrating an example of a crack.

FIG. 7 is a sectional view taken along line B-B of an RFID tag according to the embodiment of the present disclosure.

FIG. 8 is a sectional view taken along line A-A of the circuit according to the embodiment of the present disclosure.

FIG. 9 is a sectional view taken along line A-A of the circuit according to the embodiment of the present disclosure.

FIG. 10 is a sectional view taken along line A-A of the circuit according to the embodiment of the present disclosure.

FIG. 11 is a sectional view taken along line A-A of the circuit according to the embodiment of the present disclosure.

### DESCRIPTION OF EMBODIMENTS

Hereinafter, embodiments of an inspection system according to the present disclosure will be described with reference to the drawings.

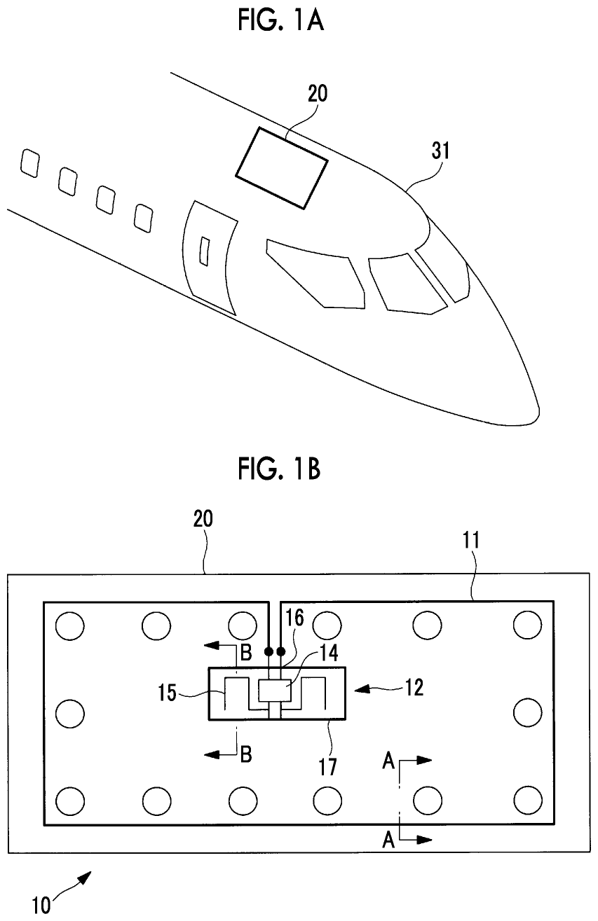

FIGS. 1A and 1B are views illustrating a schematic configuration of an inspection system 10 according to a first embodiment of the present disclosure. The inspection system 10 is applied to a moving body. In the present embodiment, a case where the inspection system 10 is applied to an aircraft 31 as a moving body will be described as an example. FIG. 1A illustrates a case where the inspection system 10 is provided for a fuselage skin 20 of the aircraft 31 as an example. The inspection system 10 is not limited to the aircraft 31, and can also be applied to various moving bodies such as a train, a spacecraft, a vehicle, and a surface vessel.

As illustrated in FIG. 1B, the inspection system 10 according to the present embodiment includes a circuit (conductive circuit, electric circuit) 11 and an RFID tag 12 as main configurations.

The circuit 11 is provided for an outer surface of the moving body, and is formed of a conductive coating material, a conductive powder, a metal thin film, or a small-diameter metal wire. The circuit 11 has conductivity.

The circuit 11 is specifically configured as follows.

A non-conductive layer is formed on a structural surface(outer surface) of the aircraft 31 by a non-conductive coating material (insulating coating material) or a non-conductor coating (non-conductor oxide coating) as a base material. That is, the structural surface of the aircraft 31 is electrically insulated from an outside thereof while the structural surface is closely attached to the non-conductive layer.

The circuit 11 is directly formed on, cured on, and closely attached to the non-conductive layer (outer side, outside a structure of the aircraft 31) formed of the non-conductive coating material or the non-conductor coating by using the conductive coating material. Alternatively, the circuit 11 is formed of the conductive powder adhering onto the non-conductive layer formed of the non-conductive coating material or the non-conductor coating. Alternatively, the circuit 11 is formed of a metal thin film or a small-diameter metal wire, and is fixed by an adhesive agent applied onto the non-conductive layer formed of the non-conductive coating material or a non-conductor coating. That is, the structural surface of the aircraft 31 and the circuit 11 are in a structurally bonded state while being electrically insulated by the non-conductive layer formed of the non-conductive coating material or the non-conductor coating. The circuit 11 is formed to have a predetermined circuit diagram for each site of the aircraft 31, and both end portions thereof are joined to sensor terminals of an RFID IC chip 14 (to be described later).

Examples of the non-conductor coating include anodizing treatment in an aluminum alloy and a passivation coating in stainless steel, but are not limited thereto.

Examples of the non-conductive coating material include an epoxy primer and a polyurethane enamel top coat, but are not limited thereto.

Examples of the adhesive agent include a cyanoacrylate adhesive agent and an epoxy adhesive agent, but are not limited thereto.

For example, the conductive coating material is a mixture in which an organic coating material is used as a solvent, and a graphite powder, a silver powder, or a conductive polymer (polymer organic compound having conductivity, a conductive molecule, or a conductive single molecule) is used as a solute. The conductive coating material is in a liquid state when applied, and may be separated into a main agent and a curing agent. A circuit pattern corresponding to a shape of an inspection target can be freely prepared by means of spraying or brushing, and after cured, the conductive coating material becomes a solid-state circuit having conductivity. Since the circuit 11 is formed of the conductive coating material, the circuit 11 has proper elasticity and adhesion to the non-conductive coating material or the non-conductor coating. Therefore, the circuit 11 can be configured as follows. When an outer surface of the aircraft 31 slightly deforms, the circuit 11 is not disconnected, and when the outer surface greatly deforms or the outer surface has a crack, the circuit 11 is disconnected. The coating material may be designed so that the circuit 11 is disconnected when the outer surface deforms as much as or beyond a predetermined deformation amount or when the outer surface has a crack.

The conductive powder is formed of a powder in which a conductive molecule or a conductive single atom capable of adhering onto the non-conductor coating or the non-conductive coating material occupies 50% or more in a composition thereof. Since the circuit 11 is formed of the conductive powder, the circuit 11 has proper elasticity and adhesion to the non-conductive coating material or the non-conductor coating. Therefore, the circuit 11 can be configured as follows. When the outer surface of the aircraft 31 slightly deforms, the circuit 11 is not disconnected, and when the outer surface greatly deforms or the outer surface has a crack, the circuit 11 is disconnected. The coating material may be designed so that the circuit 11 is disconnected when the outer surface deforms as much as or beyond a predetermined deformation amount or when the outer surface has a crack.

For example, the metal thin film is formed of a material having elasticity and strength which is similar to a structural material of the inspection target. Specifically, the metal thin film is formed of aluminum, an alloy thereof, or copper. The metal thin film has a thin shape as in a thin foil or a mesh. A cross-sectional thickness thereof is within 100 μm so that even a crack having a size which can be detected by a visual inspection imposed on the aircraft 31 can be accurately detected. The circuit 11 is formed of the metal thin film having proper material properties and a proper shape, and is closely attached to the outer surface of the aircraft 31 via an adhesive agent. In this manner, the circuit 11 can be configured as follows. When the outer surface of the aircraft 31 slightly deforms, the circuit 11 is not disconnected, and when the outer surface greatly deforms or the outer surface has a crack, the circuit 11 is disconnected. The metal thin film may be designed so that the circuit 11 is disconnected when the outer surface deforms as much as or beyond a predetermined deformation amount or when the outer surface has a crack.

For example, the small-diameter metal wire is a thin wire formed of copper or aluminum. The cross section is circular, but may be polygonal or hollow. A plurality of the small-diameter metal wires may be twisted together. An insulating layer may be provided on the surface. The circuit 11 is formed of the small-diameter metal wire having proper elasticity, and is closely attached to the outer surface of the aircraft 31 via an adhesive agent. In this manner, the circuit 11 can be configured as follows. When the outer surface of the aircraft 31 slightly deforms, the circuit 11 is not disconnected, and when the outer surface greatly deforms or the outer surface has a crack, the circuit 11 is disconnected. In addition, the small-diameter metal wire may be designed so that the circuit 11 is disconnected when the outer surface deforms as much as or beyond a predetermined deformation amount or when the outer surface has a crack.

In this way, since the circuit 11 is formed by using the conductive coating material, the conductive powder, the metal thin film, or the small-diameter metal wire, detection accuracy (precision) can be improved by utilizing the elasticity of the material.

The RFID tag 12 includes the RFID IC chip 14, an RF antenna 15, a sensor terminal 16, and a non-conductor pedestal 17. The RFID IC chip 14 includes a sensor terminal (not illustrated) and an antenna terminal (not illustrated). The RFID IC chip 14 is connected to the circuit 11 via the sensor terminal 16, and is connected to the RF antenna 15 via the antenna terminal. The RFID IC chip 14 detects an electrical continuity state of the circuit 11. The RF antenna 15 mediates communication (signal transmission/reception) and electric power supply between the RFID IC chip 14 and the outside.

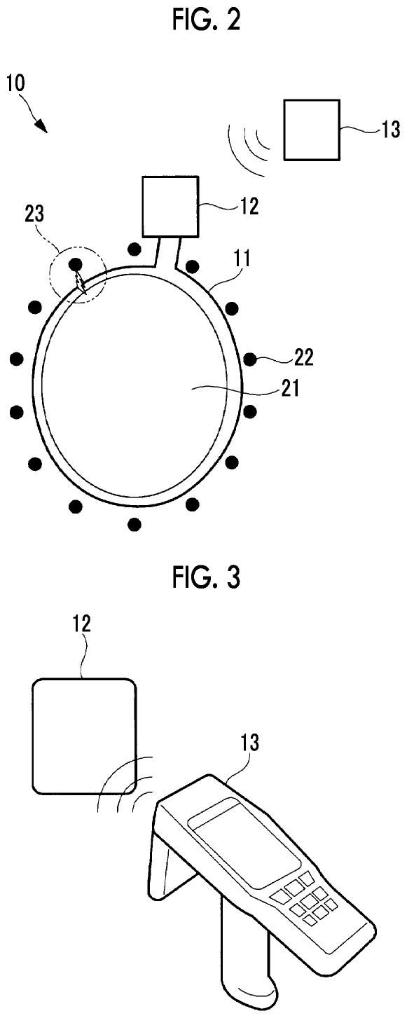

FIG. 2 is a view illustrating an example when the circuit according to the embodiment of the present disclosure is disconnected.

FIG. 2 illustrates a case where the circuit 11 is configured to surround a support portion of a window 21 in the fuselage skin 20 of the aircraft 31. The support portion of the window 21 is an opening of the fuselage skin 20, and stress concentration occurs in the support portion. A hole for a fastener 22 which fastens the fuselage skin 20 and the window 21 is provided, and is a place which is likely to have a crack. Therefore, it is preferable that the circuit 11 is provided to pass between the window 21 and the fastener 22.

As described above, FIG. 2 illustrates a case where the circuit 11 is disconnected. For example, as illustrated in the place 23 in FIG. 2, the outer surface of the fuselage skin 20 has the crack from a frame of the window 21 toward the fastener 22. In this case, the circuit 11 is disconnected accordingly, and is brought into a disconnected state.

In this way, when the outer surface of the aircraft 31 has the crack, the circuit 11 is disconnected.

The RFID IC chip 14 of the RFID tag 12 is connected to two end portions of the circuit 11 via the sensor terminal 16 to form the circuit 11 and a closed circuit. Then, the electrical continuity state of the circuit 11 is detected. For example, the electrical continuity state of the circuit 11 means detecting whether or not the circuit 11 is disconnected. That is, the RFID IC chip 14 detects whether or not the circuit 11 is disconnected. Since the RFID IC chip 14 detects whether or not the circuit 11 is disconnected, it is possible to detect a crack on the outer surface of the aircraft 31 causes the disconnection in the circuit 11.

For example, the RFID IC chip 14 detects the electrical continuity state of the circuit 11, based on whether or not a current flows through the circuit 11 (current value) or an electric resistance value of the circuit 11. A method for detecting the electrical continuity state is not limited thereto.

In the above-described example, the electrical continuity state has been described as whether or not the circuit 11 is disconnected. However, a state between a state where there is no disconnection and a state where the circuit 11 is completely disconnected may be detected as a damage state of the circuit 11. The damage state can also be determined, based on the electrical continuity state of the circuit 11.

The RF antenna 15 is connected to an antenna terminal of the RFID IC chip 14, and the RF antenna 15 is a sheet-shaped member as in the RFID tag 12, thereby forming the RFID tag 12.

FIG. 7 is a sectional view taken along line B-B of the RFID tag according to the embodiment of the present disclosure. As illustrated in FIG. 7, the RF antenna 15 is held by the non-conductor pedestal 17 at a position properly separated from an installation target surface (structure). In this manner, even when the installation target surface of the RFID tag 12 is a conductor formed of metal or CFRP through which radio waves do not pass, the RF antenna 15 maintains a state where the radio waves can be transmitted and received.

For example, the RFID tag 12 is installed by being attached to the outer surface of the aircraft 31. Electric power is wirelessly supplied to the RFID tag 12 from an RFID reader 13 (to be described later). A process for detecting the electrical continuity state of the circuit 11 is performed by using the electric power. A detection result is transmitted to the RFID reader 13 together with unique identification information inside the RFID IC chip 14. The RFID IC chip 14 is provided with an interference prevention device, and even when a plurality of the RFID tags 12 are present in a radio wave transmission range of the RFID reader 13, the RFID reader 13 can collectively read the RFID tags 12.

The RFID reader 13 wirelessly supplies the electric power to the RFID tag 12, and receives information from the RFID tag 12. Specifically, the electric power is supplied from the RFID reader 13 to the RFID tag 12, and an instruction signal is transmitted to the RFID tag 12 so that a detection result is transmitted by performing the process for detecting the electrical continuity state of the circuit 11. As a result, the RFID IC chip 14 forming the RFID tag 12 is charged with the received electric power, performs the detection process in accordance with the instruction signal, and transmits the detection result together with the unique identification information inside the RFID IC chip 14 to the RFID reader 13. In this manner, the RFID reader 13 can read the electrical continuity state of the circuit 11 which is detected at a specific place by the RFID tag 12.

For example, the RFID reader 13 is a handy type as illustrated in FIG. 3. An inspector can acquire the detection result of the RFID tag 12 by holding and bringing the RFID reader 13 close to the RFID tag 12. The RFID reader 13 is not limited to an example in FIG. 3. For example, the RFID reader 13 may be installed at a predetermined position so that the inspection can be performed by causing the aircraft 31 to pass through the vicinity thereof. The RFID reader 13 may be installed in advance in an aircraft hangar of the aircraft 31 so that the inspection can be performed after the aircraft 31 is housed in the aircraft hangar. The RFID reader 13 may be mounted on a drone to perform the inspection.

In this way, since the RFID tag 12 and the RFID reader 13 are used, the inspection can be efficiently performed, compared to the visual inspection. Therefore, safety can be improved by increasing an inspection frequency. Damage detection accuracy can be adjusted in accordance with specifications of the detection circuit, and inspection quality can be improved by suppressing human variations during the inspection. In addition, the plurality of RFID tags 12 can be collectively read by one RFID reader 13, and the inspections can be simultaneously performed over a wide range within an extremely short time. In addition, since the inspection can be performed in a non-contact manner, no invasion is required.

Next, a configuration of the outer surface of the aircraft 31 will be described.

First, the non-conductive coating material (insulating rust preventive coating material) or the non-conductor coating is applied to the outer surface of the aircraft 31, and an insulating region with respect to the outer surface is formed as a base (non-conductive layer). Then, the circuit 11 is formed on the insulating region, and the RFID tag 12 is installed. The circuit 11 is closely attached to the outer surface of the aircraft 31. Therefore, a structure is formed so that a non-conductive layer, layers of the circuit 11 and the RFID tag 12, and a non-conductive atmosphere are laminated in this order toward the outside from the outer surface of the aircraft 31. That is, the circuit 11 is in a state of being electrically insulated by a non-conductive member. Since each of the layers of the circuit 11 and the RFID tag 12 and the non-conductive layer is formed in a thin film shape, a system is formed without generating large irregularities on the outer surface of the aircraft 31.

FIG. 8 is a sectional view taken along line A-A of the circuit according to the embodiment of the present disclosure. The circuit 11 illustrated in FIG. 8 is formed of the conductive coating material or the conductive powder on the non-conductive layer (outer side, outside the structure of the aircraft 31) formed of the non-conductive coating material or the non-conductor coating.

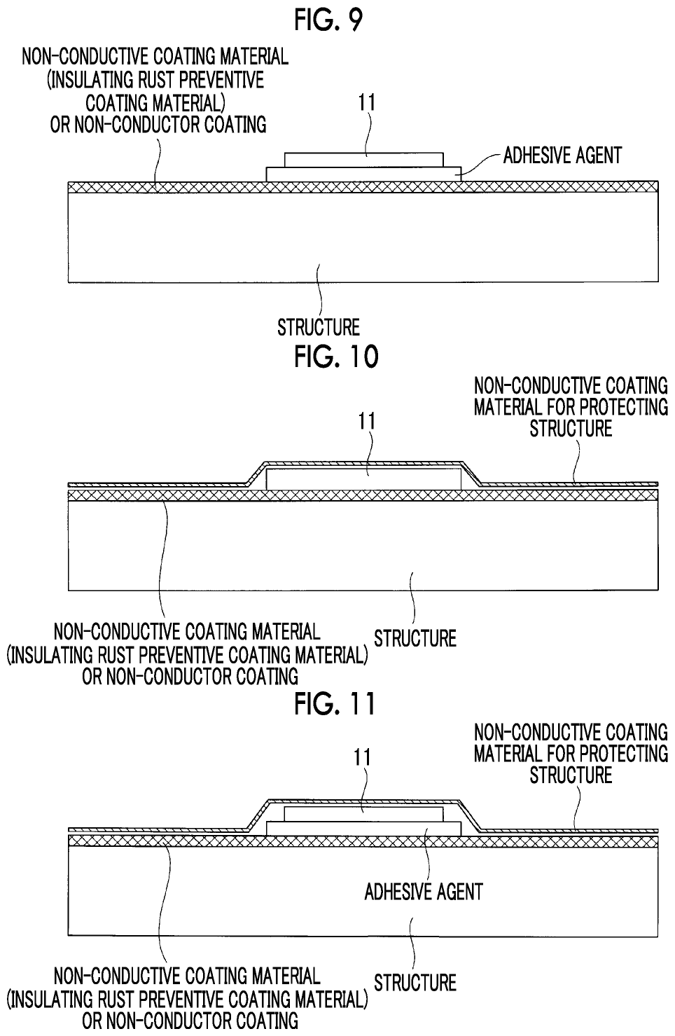

FIG. 9 is a sectional view taken along line A-A of the circuit according to the embodiment of the present disclosure. The circuit 11 illustrated in FIG. 9 is formed of a metal thin film or a small-diameter metal wire. The circuit 11 is fixed by an adhesive agent applied onto the non-conductive layer formed of the non-conductive coating material or the non-conductor coating.

In addition, a predetermined region including an installation region for the circuit 11 and the RFID tag 12 and other regions may be continuously covered with a non-conductive coating material for protecting the structure.

FIG. 10 is a sectional view taken along line A-A of the circuit according to the embodiment of the present disclosure. The circuit 11 illustrated in FIG. 10 is formed of the conductive coating material or the conductive powder on the non-conductive layer (outer side, outside the structure of the aircraft 31) formed of the non-conductive coating material or the non-conductor coating. The circuit 11 as a whole is covered with the non-conductive coating material for protecting the structure.

FIG. 11 is a sectional view taken along line A-A of the circuit according to the embodiment of the present disclosure. The circuit 11 illustrated in FIG. 11 is formed of the metal thin film or the small-diameter metal wire. The circuit 11 is fixed by an adhesive agent applied onto the non-conductive layer formed of the non-conductive coating material or the non-conductor coating. The circuit 11 as a whole is covered with the non-conductive coating material for protecting the structure.

Since the circuit 11 is covered with the non-conductive coating material for protecting the structure, the moving body can be smoothed by suppressing a step difference on the surface while an economically valuable external appearance is maintained. Therefore, the circuit 11 can be applied to a moving body that is sensitive to an impact of air resistance (for example, a high-speed moving body) or a moving body that has an important external appearance (for example, a sports car).

In addition, the predetermined region including the installation region for the circuit 11 and the RFID tag 12 and other regions may be continuously covered with a non-conductive heat insulating material for retaining heat. The moving body can be smoothed by suppressing the step difference on the surface while a thermal environment inside the moving body is maintained. Therefore, the circuit 11 can be applied to a moving body (for example, a rocket or a hydrogen aircraft) that is sensitive to the impact of the air resistance.

For example, the non-conductive coating material for protecting the structure includes polyurethane enamel and epoxy primer, but is not limited thereto.

For example, the non-conductive heat insulating material for retaining heat includes urethane foam heat insulating material and glass wool, but is not limited thereto.

After being covered with the non-conductive coating material for protecting the structure, it is preferable that an installation position of the RFID tag 12 is marked to be recognizable from the outside. In addition, it is preferable that the installation position of the RFID tag 12 and the unique identification information inside the RFID IC chip 14 of the RFID tag 12 are recorded in advance in combination with each other.

Next, a specific installation place of the circuit 11 will be described.

Since the inspection system 10 detects damage to the outer surface of the aircraft 31, it is preferable that the circuit 11 is disposed at a place which is likely to be damaged. For example, the place which is likely to be damaged is a cutout position (end portion of a member) or a place where high stress is generated (a place where stress concentration is likely to occur). That is, it is preferable to provide the circuit 11 around the cutout position or the stress concentration place.

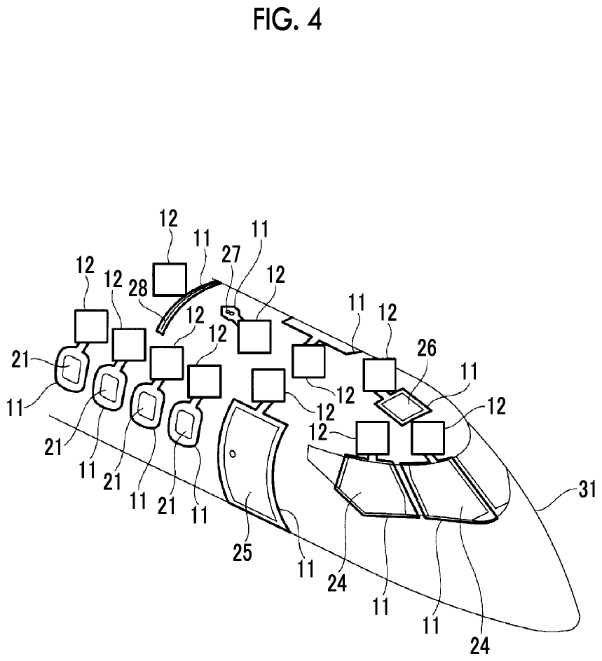

FIG. 4 is a view illustrating an example when the circuit 11 is installed in the aircraft 31. FIG. 4 illustrates an example when the circuit 11 is provided around the cutout position of the aircraft structure. As illustrated in FIG. 4, the circuit 11 is provided to surround a window (for example, a cabin window) 21 of the aircraft 31, a cockpit windshield 24 of the aircraft 31, a door (door) 25, a door (emergency exit) 26, and an antenna attachment place 27 on the outer surface. In addition, the circuit 11 may be provided to pass through the vicinity (range in which crack growth is expected) of a fastener fastening portion (fastener portion) 28 on the outer surface. The fastener fastening portion 28 is a contact portion between a member forming the aircraft 31 and a member, and particularly indicates a portion including a portion around an opening open in the member and the fastener 22 inserted into the opening.

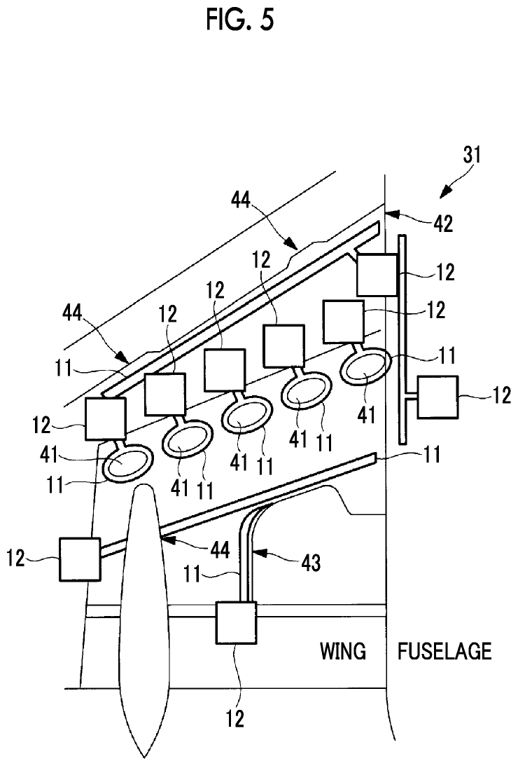

FIG. 5 is a view illustrating an example when the circuit 11 is installed in the aircraft 31. FIG. 5 is a view when the aircraft 31 is viewed from below. FIG. 5 illustrates an example when the circuit 11 is provided around a stress concentration place of the aircraft structure. As illustrated in FIG. 5, the circuit 11 is provided to surround a manhole 41. In addition, the circuit 11 is provided to pass through the vicinity (range in which crack growth is expected) with respect to each of a joining portion 42 of a wing body, an attachment portion 43 of a landing device, and a metal fitting attachment portion 44. The manhole 41 is a mouth for accessing the inside, and is closed by a lid. Metal fittings are metal fittings attached to the aircraft 31. For example, the vicinity is a range of 2.5 cm from an end (or contact portion) of a target portion where the circuit 11 is provided.

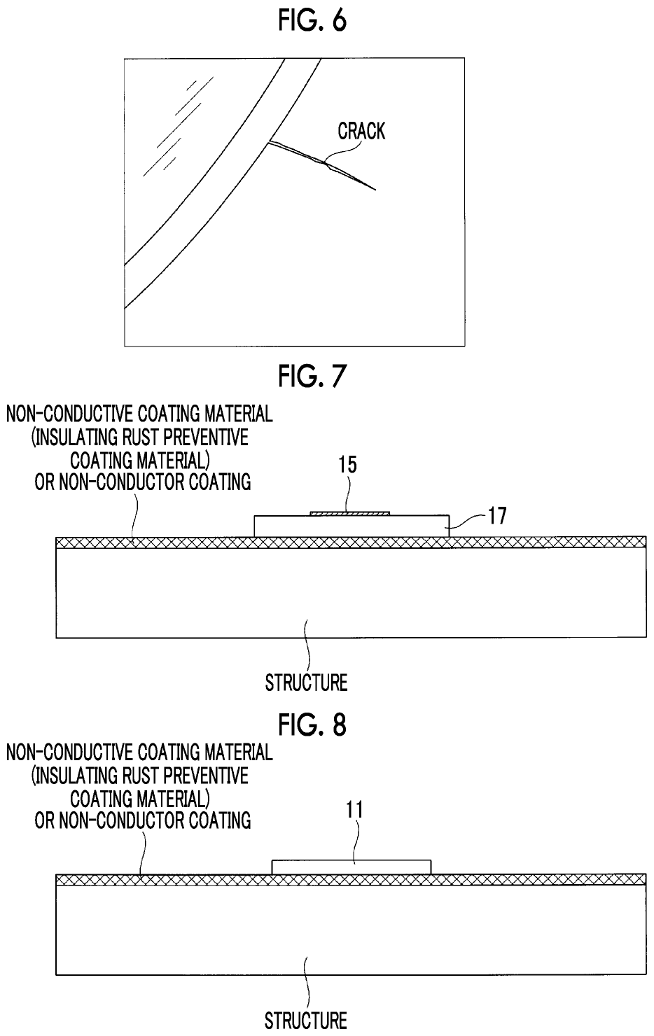

FIG. 6 illustrates an example of a crack. When the circuit 11 is damaged as illustrated in FIG. 6, the circuit 11 is disconnected due to the damage, and the damage is detected by the RFID tag 12.

An installation place of the circuit 11 illustrated in FIGS. 4 to 5 is not limited to the aircraft 31, and may be applied to other moving bodies as long as other moving bodies have the same configuration. In addition, an installation position of the circuit 11 is not limited to the outer surface, and may be provided inside a structure of the moving body.

As described above, according to the inspection system in the present embodiment, the conductive circuit 11 formed of the conductive coating material, the conductive powder, the metal thin film, or the small-diameter metal wire on the outer surface of the moving body, and the RFID IC chip 14 of the RFID tag 12 form a closed circuit. Therefore, since the electrical continuity state (current value or resistance value) of the circuit 11 is detected by the RFID IC chip 14 of the RFID tag 12, it is possible to detect a state such as a crack on the outer surface of the moving body. Since a state can be read at a high speed with the plurality of RFID tags 12 at one time, the inspection can be more efficiently performed. It is possible to increase an inspection frequency, and thus, improved safety can be expected.

In addition, since the non-conductor pedestal 17 holds the sensor terminal 16, the RF antenna 15, and the RFID IC chip 14, a remote inspection using the RFID reader 13 and the RFID IC chip 14 can be performed even for an inspection target such as metal and CFRP through which radio waves do not pass.

Since the circuit 11 formed of the conductive coating material, the conductive powder, the metal thin film, or the small-diameter metal wire, and the RFID tag 12 are used, an increase in the air resistance of the moving body can be suppressed by minimizing protrusion of the outer surface of the moving body.

Since the circuit 11 is formed of the conductive coating material, the conductive powder, the metal thin film, or the small-diameter metal wire, the circuit 11 is disconnected along the outer surface of the moving body. On the other hand, when the outer surface of the moving body slightly deforms such as distortion of the outer surface of the moving body, the electrical continuity state of the circuit 11 is maintained by elasticity of the material, and erroneous damage detection is suppressed.

The circuit 11; the RFID tag 12; a predetermined region around the circuit 11 and the RFID tag 12, and other regions on the outer surface of the moving body are covered with an exterior material such as a continuous non-conductive coating material or a non-conductive heat insulating material. Therefore, the moving body can be smoothed by suppressing a step difference on the surface. In addition, it is possible to compatibly achieve economic efficiency and functionality such as an external appearance and heat insulation without impairing both of these.

The present disclosure is not limited to only the embodiments described above, and various modifications can be made within a scope which does not depart from the concept of the invention.

For example, the inspection system described in each of the above-described embodiments is understood as follows.

According to the present disclosure, there is provided the inspection system (10 applied to the moving body (31). The inspection system (10) includes the conductive circuit (11) provided on the insulating coating material or the non-conductor coating on the structural surface of the moving body and closely attached to the insulating coating material or the non-conductor coating, the RFID IC chip (14) including the sensor terminal (16) connected to the conductive circuit and the RF antenna terminal connected to the RF antenna (15), and detecting the electrical continuity state of the conductive circuit, and the non-conductor pedestal (17) that holds the sensor terminal, the RF antenna, and the RFID IC chip at proper positions.

The inspection system according to the present disclosure includes the conductive circuit provided on the insulating coating material or the non-conductor coating on the structural surface of the moving body and closely attached to the insulating coating material or the non-conductor coating, and the RFID IC chip including the sensor terminal connected to the conductive circuit and the RF antenna terminal connected to the RF antenna, and detecting the electrical continuity state of the conductive circuit. Therefore, since the electrical continuity state (disconnection or resistance) of the conductive circuit is detected by the RFID IC chip, it is possible to detect a state such as a crack on the surface of the moving body. Since the state can be read by the RFID IC chip, the inspection can be more efficiently performed. It is possible to increase an inspection frequency, and thus, improved safety can be expected.

In addition, since the non-conductor pedestal holds the sensor terminal, the RF antenna, and the RFID IC chip, a remote inspection using the RFID reader and the RFID IC chip can be performed even for the inspection target such as metal and CFRP through which radio waves do not pass.

Since the conductive circuit provided on the insulating coating material or the non-conductor coating on the structural surface of the moving body and closely attached to the insulating coating material or the non-conductor coating and the RFID IC chip are used, an increase in the air resistance of the moving body can be suppressed by suppressing a step difference on the surface of the moving body.

Since the conductive circuit is formed of the insulating coating material or the non-conductor coating, the circuit is disconnected along the surface of the moving body. On the other hand, when the surface of the moving body slightly deforms such as distortion of the surface of the moving body, the state of the circuit is maintained by elasticity of the material, and erroneous detection is suppressed.

In the inspection system according to the present disclosure, the insulating coating material or the non-conductor coating may have interfacial strength by which the insulating coating material or the non-conductor coating is closely attached to the moving body.

According to the inspection system in the present disclosure, the insulating coating material or the non-conductor coating has the interfacial strength by which the insulating coating material or the non-conductive coating is closely attached to the moving body. Therefore, the insulating coating material or the non-conductive coating material can form a layer for protecting the structure of the moving body from corrosion or external damage.

In the inspection system according to the present disclosure, the conductive circuit may be formed of the conductive coating material which is the organic compound solvent containing the conductive molecule or the conductive single atom as the solute and closely attached to the insulating coating material or the non-conductor coating when cured.

According to the inspection system in the present disclosure, the conductive circuit is formed of the conductive coating material which is the organic compound solvent containing the conductive molecule or the conductive single atom as the solute and closely attached to the insulating coating material or the non-conductor coating during curing. Therefore, in addition to conductivity, the circuit is formed to have close attachment capability when cured.

In the inspection system according to the present disclosure, the conductive circuit may be configured to adhere to the insulating coating material or the non-conductor coating, and may be formed of the conductive powder in which the conductive molecule or the conductive single atom occupies 50% or more in the composition.

According to the inspection system in the present disclosure, the conductive circuit is configured to adhere to the insulating coating material or the non-conductor coating, and is formed of the conductive powder in which the conductive molecule or the conductive single atom occupies 50% or more in the composition. Therefore, in addition to conductivity, the circuit is formed to have adhesion capability when formed.

In the inspection system according to the present disclosure, the conductive circuit may be formed of the metal thin film having the thickness of 70 μm or smaller or the metal wire having the diameter of 200 μm or smaller, which is bonded to the insulating coating material or the non-conductor coating via the adhesive agent.

According to the inspection system in the present disclosure, the conductive circuit is formed of the metal thin film having the thickness of 70 μm or smaller or the metal wire having the diameter of 200 μm or smaller, which is bonded to the insulating coating material or the non-conductor coating via the adhesive agent. Therefore, damage can be reliably detected by controlling the dimensions of the metal thin film or the metal wire to be equal to or smaller than a fixed value so that the interfacial strength of the adhesive agent is superior.

In the inspection system according to the present disclosure, the RFID IC chip may wirelessly perform electric power reception and signal transmission/reception via the RF antenna, and may detect whether or not the conductive circuit is disconnected.

According to the inspection system in the present disclosure, whether or not the circuit is disconnected is detected by the RFID IC chip. Therefore, a crack on the surface of the moving body can be detected.

In the inspection system according to the present disclosure, a predetermined region including the installation region for the conductive circuit and the RFID IC chip and other regions may be covered with the non-conductive material.

According to the inspection system in the present disclosure, the predetermined region including the installation region for the conductive circuit and the RFID IC chip and other regions are covered with the non-conductive material. Therefore the moving body can be smoothed by suppressing a step difference on the surface of the moving body.

The inspection system according to the present disclosure may include the RFID reader (13) that performs electric power supply to the RFID IC chip and information transmission/reception to/from the RFID IC chip via the RF antenna.

According to the inspection system in the present disclosure, the electrical continuity state of the conductive circuit detected by the RFID IC chip can be read by the RFID reader.

The inspection system according to the present disclosure may include the non-conductor pedestal that holds the RF antenna and the RFID IC chip. According to the inspection system in the present disclosure, the non-conductor pedestal having proper dimensions is applied between the RF antenna and the structure which is the inspection target. Therefore, even for an inspection target such as metal or CFRP through which radio waves do not pass, the remote inspection using the RFID reader and the RFID IC chip can be performed, and it is possible to improve capability for the electric power reception from the RF reader and the signal transmission/reception to/from the RF reader.

### REFERENCE SIGNS LIST

10: Inspection system
11: Circuit (conductive circuit)
12: RFID tag
13: RFID reader
14: RFID IC chip
15: RFID antenna
20: Fuselage skin
21: Window
22: Fastener
23: Place
24: Cockpit windshield
27: Attachment place
31: Aircraft
41: Manhole
42: Joining portion
43: Attachment portion
44: Metal fitting attachment portion

1. An inspection system applied to a moving body, comprising:
a conductive circuit provided on an insulating coating material or a non-conductor coating on a structural surface of the moving body and closely attached to the insulating coating material or the non-conductor coating; and
an RFID IC chip including a sensor terminal connected to the conductive circuit and an RF antenna terminal connected to an RF antenna, and detecting an electrical continuity state of the conductive circuit.

2. The inspection system according to claim 1,
wherein the insulating coating material or the non-conductor coating has interfacial strength by which the insulating coating material or the non-conductor coating is closely attached to the moving body.

3. The inspection system according to claim 1,
wherein the conductive circuit is formed of a conductive coating material which is an organic compound solvent containing a conductive molecule or a conductive single atom as a solute, and closely attached to the insulating coating material or the non-conductor coating when cured.

4. The inspection system according to claim 1,
wherein the conductive circuit is configured to adhere to the insulating coating material or the non-conductor coating, and is formed of a conductive powder in which a conductive molecule or a conductive single atom occupies 50% or more in a composition.

5. The inspection system according to claim 1,
wherein the conductive circuit is formed of a metal thin film having a thickness of 70 μm or smaller or a metal wire having a diameter of 200 μm or smaller, which is bonded to the insulating coating material or the non-conductor coating via an adhesive agent.

6. The inspection system according to claim 1,
wherein the RFID IC chip wirelessly performs electric power reception and signal transmission/reception via the RF antenna, and detects whether or not the conductive circuit is disconnected.

7. The inspection system according to claim 1,
wherein a predetermined region including an installation region for the conductive circuit and the RFID IC chip and other regions are covered with a non-conductive material.

8. The inspection system according to claim 1, further comprising:
an RFID reader that performs electric power supply to the RFID IC chip and information transmission/reception to/from the RFID IC chip via the RF antenna.

9. The inspection system according to claim 1, further comprising:
a non-conductor pedestal that holds the RF antenna and the RFID IC chip.
